(19) United States
(12) Patent Application Publication
(10) Pub. No.: US 2013/0119078 A1
(43) Pub. Date: May 16, 2013

(54) Installable Push-On Cookware Handle Insulator

(71) Applicant: Xiaorong Cygan, Hoffman Estates, IL (US)

(72) Inventor: Xiaorong Cygan, Hoffman Estates, IL (US)

(21) Appl. No.: 13/296,234

(22) Filed: Nov. 15, 2011

(51) Int. Cl. A47J 45/10; B23P 11/00; A47J 45/07

(52) U.S. Cl. 220/753; 29/428

(57) ABSTRACT

A cookware handle insulator has a main body formed from a thermal insulating material and has an outer surface providing a cold surface. A slot aperture runs longitudinally along an axis of the main body and provides an inner surface and a space to accommodate a longitudinal cookware handle. The inner surface provides a hot surface of the main body. Flexible slot edges extend inwardly toward the slot aperture and have a taper for engaging a longitudinal cookware handle surface when the cookware handle insulator is pushed onto the cookware handle. The slot edge inner surface engages the longitudinal cookware handle surface and maintains the cookware handle insulator position on the cookware handle when the cookware handle insulator is installed. Another embodiment has a substantially triangular cross-section with two flexible side sections to clasp the cookware handle when installed. A method of installing the cookware handle insulator is also provided.

### FIELD OF THE DISCLOSURE

The present disclosure relates generally to cookware handle insulation, and to cookware holders like pot holders or pan handle holders.

### BACKGROUND

Various models of cookware exist on the market, such as pots, pans, etc., that provide various type of handles. Some cookware models provide wooden or plastic handles, or coated metal handles, that provide heat insulation so that a person can grip the handle to lift the cookware from the stove during or after heating, when the main body of the cookware is heated beyond what would be safe or comfortable for a person to touch. Many high-end models of cookware today are made from materials that conduct heat, such as stainless steel, and do not provide insulated handles.

### BRIEF DESCRIPTION OF THE DRAWINGS

FIG. 1A is a perspective view of an installable push-on cookware handle insulator in accordance with an embodiment.

FIG. 1B is another perspective view of the installable push-on cookware handle insulator of FIG. 1A, after the installable push-on cookware handle insulator has been rotated about a cookware handle such as a pot handle.

FIG. 2 is a top, end and bottom view of an installable push-on cookware handle insulator in accordance with an embodiment.

FIG. 3 is a top, end and bottom view of an installable push-on cookware handle insulator in accordance with an embodiment.

FIG. 4 is a perspective view of an installable push-on cookware handle insulator, installed on a pan handle, in accordance with the embodiment of FIG. 3.

FIG. 5 is a perspective view of an installable push-on cookware handle insulator in accordance with an embodiment.

FIG. 6 is a cross-sectional view in accordance with the embodiment shown in FIG. 5.

### DETAILED DESCRIPTION

The present disclosure describes an installable push-on cookware handle insulator that may be conveniently installed and removed on a cookware handle, such as a pot cover handle, or on the handles on the sides of a pot. Among the advantages provided, a user may install the disclosed cookware handle insulator by pushing it onto a cookware handle and may leave it in place while cooking, thereby having the convenience of being able to lift the cookware item at any time. Multiple installable, push-on cookware handle insulators can be installed on a cookware set, providing convenient thermal insulation to the previously un-insulated cover handles and/or pot handles, etc.

The embodiments disclosed include a cookware handle insulator comprising a main body formed from a thermal insulating material having an outer surface providing a cold surface; a slot aperture running longitudinally along an axis of the main body and providing an inner surface of the main body, the slot aperture providing a space to accommodate a longitudinal cookware handle, the inner surface providing a hot surface of the main body. The cookware handle insulator also has flexible slot edges that extend inwardly toward the slot aperture, and have a taper on the slot edge outer surfaces for engaging a longitudinal cookware handle surface when the cookware handle insulator is pushed onto the cookware handle. The slot edge inner surfaces engage the cookware cover handle surface and maintain the cookware handle insulator position on the cookware cover handle when the cookware handle insulator is installed on the cookware handle, such as a pot cover handle or pot handle.

The cookware handle insulator main body may have a substantially c-shaped cross-section formed by the slot aperture and by the flexible slot edges. The cookware handle insulator main body outer surface may also have a series of alternating raised grip bars and nub pairs to make the cookware handle insulator easier to grip. The cookware handle insulator may be made from a thermal insulating material such as synthetic rubber, silicone, or any other suitable thermal insulating material that may be formed into the described forms.

The cookware handle insulator main body may also have a square, rectangular, or triangular cross-section in some embodiments.

Another embodiment of an installable push-on cookware handle insulator is disclosed that has a main body formed from a thermal insulating material comprising a bottom section and two side sections. The two side sections are connected to, and form acute angles with, the bottom section with respect to inner surfaces of the two side sections and the bottom section. The inner surfaces of the two side sections and the bottom section collectively form a slot aperture and provide a hot surface. The aperture space accommodates a longitudinal cookware handle, where the two side sections can flexibly clasp onto the longitudinal cookware handle surface and maintain the cookware handle insulator position on the cookware handle when the cookware handle insulator is installed on the cookware handle.

There are also two slot edges which each extend outwardly away from a corresponding side section of the two side sections and away from the slot aperture. Each slot edge has a slot edge inner surface for engaging the longitudinal cookware handle surface, such as a pot handle surface, when the cookware handle insulator is pushed onto the cookware handle.

The cookware handle insulator main body has a substantially triangular shaped cross-section formed by the two side sections and the bottom section. The main body outer surface may also have a series of alternating raised grip bars and nub pairs, extending outwardly from the main body outer surface, to make it easier to grip the cookware handle insulator.

This cookware handle insulator may also be made from a thermal insulating material such as synthetic rubber, silicone, or any other suitable thermal insulating material that may be formed into the described forms.

A method of installing the cookware handle insulator is also described which includes aligning a longitudinal axis of a cookware handle insulator main body with a longitudinal axis of a cookware handle of a cookware item; positioning a slot aperture of the cookware handle insulator with the cookware handle; and applying a downward pressure to push the cookware handle insulator onto the cookware handle until the cookware handle is within the slot aperture and at least one flexible portion of the cookware handle insulator clasps the cookware handle. The cookware handle insulator may also be rotated so that the slot aperture is positioned away from the cookware item.

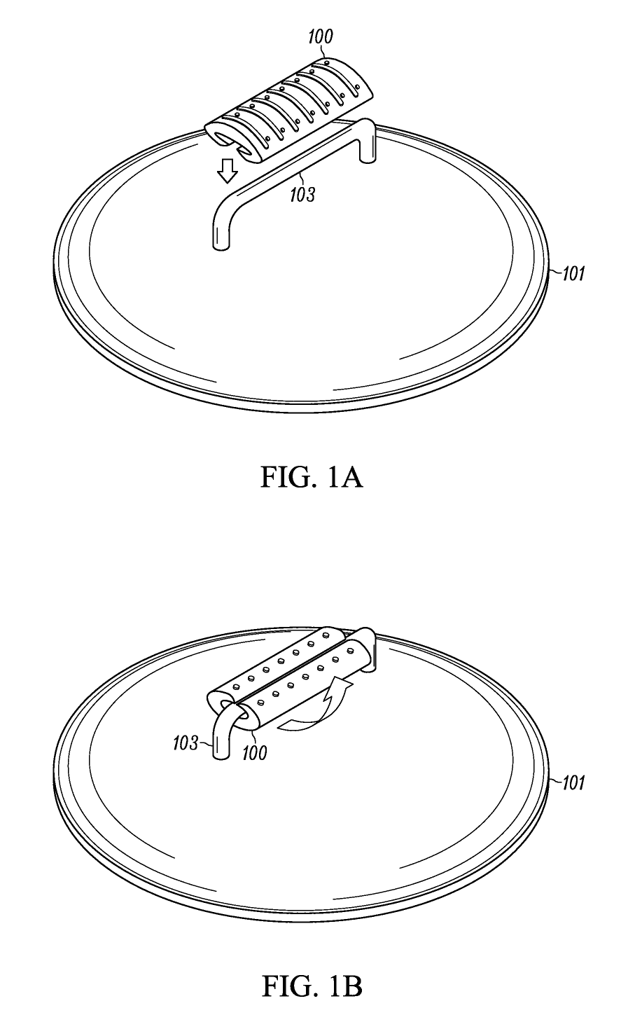

Turning now to the drawings wherein like numerals represent like components, FIG. 1 provides a perspective view of an installable push-on cookware handle insulator in accordance with an embodiment. The installable push-on cookware handle insulator 100 as shown in FIG. 1A may be longitudinally aligned along an axis with a cookware handle 103 of a cookware cover 101. The installable push-on cookware handle insulator 100 may also be used on, for example, the pot handles positioned on each side of a pot, etc. By placing the installable push-on cookware handle insulator 100 over and aligning it lengthwise with, the cookware handle 103, and applying a slight downward force the installable push-on cookware handle insulator 100 may be snapped onto the cookware handle 103. FIG. 1B illustrates that the installable push-on cookware handle insulator 100 may be rotated about the cookware handle 103 in order to position the open portion of the installable push-on cookware handle insulator 100 upwards, and away from the cookware 101. This provides further heat insulation to the hand and fingers when gripping the cookware handle 103 or placing the fingers underneath the cookware handle 103 in order to lift the cookware 101. The cross-section of the installable push-on cookware handle insulator 100, allows flexibility with respect to the height, and/or width of the cross-sectional area of the installable push-on cookware handle insulator 100, such that the installable push-on cookware handle insulator 100 provides a squeezing force to clasp onto, and remain in place on, the handle.

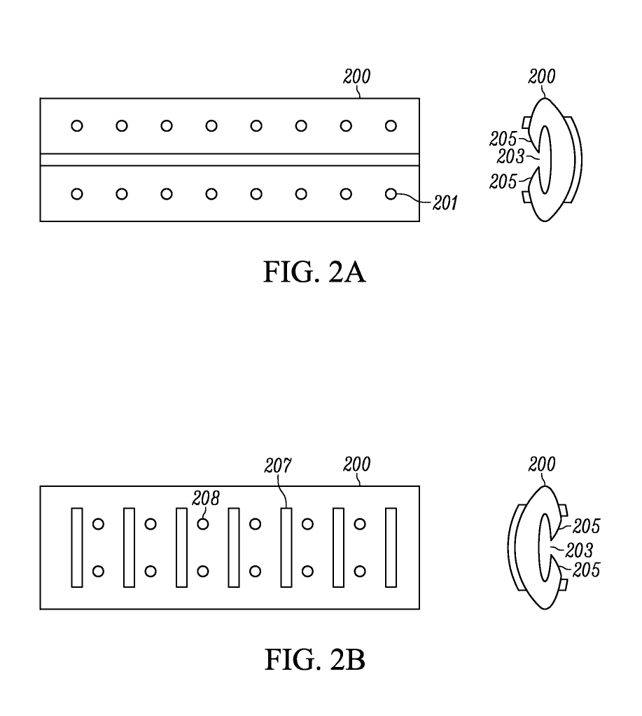

FIG. 2 illustrates further details of an installable push-on cookware handle insulator 200. FIG. 2A may be considered a bottom view of the main body of installable push-on cookware handle insulator 200. It is to be understood however that terms such as “top,” “bottom,” “end,” etc., are relative terms that are used only for enabling description of the embodiments herein described to those of ordinary skill. In other words these terms, as used in this description, are not to be viewed as limiting the embodiments to any particular configuration, but merely as relative terms useful for facilitating description of the various embodiments.

Thus in FIG. 2A a slot aperture 203 may be considered as being located on the bottom of the main body of installable push-on cookware handle insulator 200. The slot aperture 203 runs longitudinally along an axis of the installable push-on cookware handle insulator 200 main body, and provides a space that is dimensioned to accommodate most longitudinal cookware handles, such as cookware handle 103 illustrated in FIG. 1A and FIG. 1B. More particularly, the slot aperture 203 height and/or width, may be less than the diameter of cookware handle 103, by a tolerance within a range of, for example, +/−2.0 mm, or some other acceptable tolerance as understood by those of ordinary skill, such that the installable push-on cookware handle insulator 200 fits snuggly when installed on a cookware handle.

A distance between the end points of the flexible slot edges 205 (best seen in the end views of FIG. 2A and FIG. 2B) may be such that the flexible slot edges 205 may compress slightly to slip over the cookware handle 103 when the installable push-on cookware handle insulator 200 is pushed onto the cookware handle 103 as shown in the example provided in FIG. 1A and FIG. 1B. The installable push-on cookware handle insulator 200 may be fabricated in different sizes to accommodate variations in handle diameters or girths. It is to be understood that, although the various FIGs. provide illustrations of round handles, the handles need not be round in the various embodiments. That is, the cookware handle insulator of the embodiments may be used on cookware handles having cross-sectional shapes other than circular. The distance between the flexible slot edges 205 provides sufficient space in order for the flexible slot edges 205 to flex to allow the cookware handle insulator 200 to be pushed onto most cookware handles, which have cookware handle sizes as understood by those of ordinary skill. The flexible slot edges 205 may extend inwardly, toward the slot aperture 203, such that the cookware handle 103 may be pushed against the inwardly extending flexible slot edges 205, and into the slot aperture 203. The outer surfaces of the flexible slot edges 205 may slide against the surface of the cookware handle 103 as it is pushed inward into the slot aperture 203, and may subsequently pop or snap outwardly and over the surface of the cookware handle 103. That is, when the cookware handle 103 is positioned within the slot aperture 203, the inner surfaces of the flexible slot edges 205 may make contact with the surface of the cookware handle 103, such that the flexible slot edges 205 hold the installable push-on cookware handle insulator 200 in-place on the cookware handle 103. The installable push-on cookware handle insulator 200 may also be rotated about the cookware handle 103 as shown in FIG. 1B, because the flexible slot edges 205 will hold the installable push-on cookware handle insulator 200 in-place.

As shown in the end views of FIG. 2A and FIG. 2B, the flexible slot edges 205 may be tapered such that they may more easily slide over a cookware handle and snap into place, surrounding the cookware handle within the slot aperture 203. The flexible slot edges 205 provide the advantage of the installable push-on cookware handle insulator 200 grasping or clasping onto a cookware handle and maintaining the installable push-on cookware handle insulator 200 in-place on the handle such that it is “installed.” In other words, the installable push-on cookware handle insulator 200 has the advantage of remaining in place on the cookware handle to provide heat insulation. As shown in FIG. 2A and FIG. 2B, the installable push-on cookware handle insulator 200 may have a substantially “c-shaped” cross section, that is, shaped similar to the letter “c.” The installable push-on cookware handle insulator 200 cross section, as shown in FIG. 2A and FIG. 2B, is “substantially” c-shaped in that the inner portion of the “letter C,” formed by the slot aperture 203, may be, in the various embodiments, an oval shape as shown, a circular shape, a hexagon shape, an octagon shape, etc. Other cross-sectional shapes, that are not substantially c-shaped, may also be used in the various embodiments such as, but not limited to, a square shape, a rectangular shape, a triangular shape, etc. The oval shape of the substantially c-shaped cross section provides an advantage in that the cookware handle insulator 200 main body may flex, with respect to the height, and/or width of the cross-sectional area of the installable push-on cookware handle insulator 200, to form a snug fit around a cookware handle, enabling the cookware handle insulator 200 to remain in position. Put another way, the installable push-on cookware handle insulator 200 provides a squeezing force to clasp onto, and remain in place on, the cookware handle.

As shown in the example of FIG. 2A, the bottom of the installable push-on cookware handle insulator 200 may include raised nubs 201, located on an outer surface of the flexible slot edges 205, to facilitate gripping the installable push-on cookware handle insulator 200. Likewise, the top portion, as shown in FIG. 2B, may include a series of alternating raised grip bars 207 and nub pairs 208 located on the installable push-on cookware handle insulator 200 top outer surface. The raised grip bars 207, and also the nub pairs 208, may be arranged perpendicular, or orthogonally, with respect to the longitudinal axis of the installable push-on cookware handle insulator 200 main body. The inner surface of the installable push-on cookware handle insulator 200, more specifically the inner surface of the slot aperture 203, comes in contact with a cookware handle and may be considered to be the “hot face” or “hot surface” of the installable push-on cookware handle insulator 200. In contrast, the outer surface of the installable push-on cookware handle insulator 200, more specifically the installable push-on cookware handle insulator 200 top outer surface and the bottom outer surface of the flexible slot edges 205, may be considered to be the “cold face” or “cold surface” of the installable push-on cookware handle insulator 200. That is, the hot face may come into contact with a heated cookware handle while the cold face may come into contact with a person's hand and/or fingers due to the heat insulation provided by the material of the installable push-on cookware handle insulator 200. In other words, the heat insulation properties of the installable push-on cookware handle insulator 200 enables a person to grasp a heated cookware handle by grasping the installable push-on cookware handle insulator 200 cold face or cold surface.

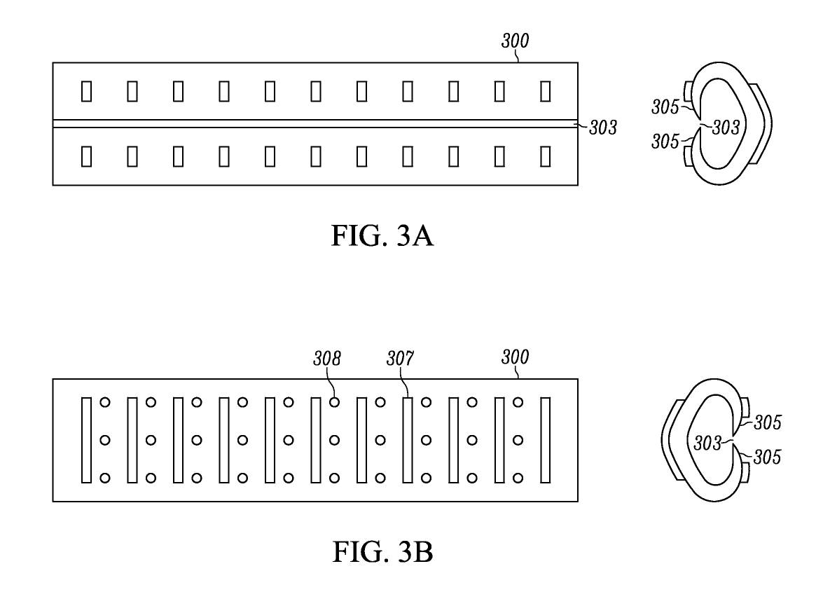

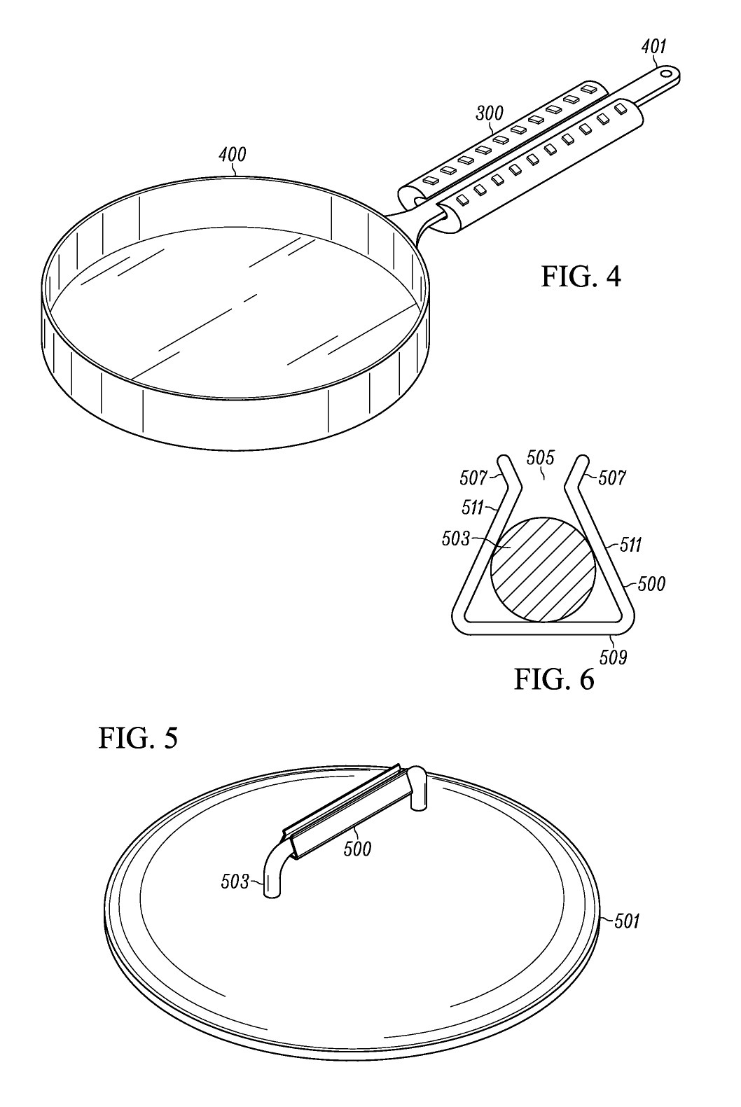

FIG. 3A and FIG. 3B provide the bottom and end view, and top and end view, respectively, of an embodiment of an installable push-on cookware handle insulator 300. As shown in FIG. 3A and FIG. 3B, the slot aperture 303, and overall length, may be sized larger than that of installable push-on cookware handle insulator 200 embodiment, so that the installable push-on cookware handle insulator 300 may accommodate the length of, for example, a frying pan or skillet. FIG. 4 illustrates the installable push-on cookware handle insulator 300 installed on the handle 401 of a pan 400. As shown in FIG. 4, a cold face, or cold surface, of the installable push-on cookware handle insulator 300 contacts the handle 401 of pan 400.

FIG. 5 and FIG. 6 provide details of another embodiment of an installable push-on cookware handle insulator 500. In the perspective view of FIG. 5, the installable push-on cookware handle insulator 500 is shown installed on cookware handle 503 of cookware cover 501. A cross-sectional view in FIG. 6 illustrates that an inner surface, forming a cold face or cold surface, is located within a slot aperture 505 and is formed by three sections forming a somewhat triangular shape as shown. The cross-sectional triangular shape is substantially triangular in that, a slot aperture 505 is provided to enable installation onto a cookware handle 503. The cross-section is “substantially” triangular in that the two side sections 511 form acute angles with the bottom section 509, with respect to the inner surface of the installable push-on cookware handle insulator 500 main body. The cross-sectional triangular shape is also “substantially” triangular in that the “corners” of the triangular shape may be rounded rather than forming precise corners. As shown in FIG. 6 the substantially triangular, cross-section is formed by two side sections 511, and a bottom section 509. Inner surfaces of the two side sections 511, and an inner surface of the bottom section 509, the inner surfaces collectively forming the slot aperture 505, collectively provide the hot face or hot surface of the installable push-on cookware handle insulator 500. The corresponding outer surfaces of the two side sections 511, and an outer surface of the bottom section 509, collectively provide the cold face or cold surface of the installable push-on cookware handle insulator 500.

The installable push-on cookware handle insulator 500 may also include two outwardly extending slot edges 507. The outwardly extending slot edges 507, which outwardly extend from the slot aperture 505, provide inner surfaces that may make contact with the cookware handle 503 during installation, and enable the cookware handle 503 to slide into the slot aperture 505 when the installable push-on cookware handle insulator 500 is pushed onto the cookware handle 503. The cookware handle 503 is grasped or clasped by the inner surfaces of the two side sections 511, when the installable push-on cookware handle insulator 500 is installed. The outwardly extending slot edges 507, each extend outwardly away from the slot aperture 505, and form an obtuse angle with respect to the outer surfaces (i.e. the cold faces) of their corresponding side sections 511. The two side sections 511 are flexible with respect to the bottom section 509, so as to open to allow installation of the cookware handle insulator 500 main body onto the longitudinal cookware handle 503. The flexible two side sections 511 also provide a squeezing or clasping force, to keep the cookware handle insulator 500 in position on the handle 503. In this embodiment, the outwardly extending slot edges 507 need not be flexible and may remain relatively rigid with respect to the two side edges 511. That is, as a property of the thermal insulating material, the angles between the bottom section 509 and the two side sections 511, forming the substantially triangular cross-section of the main body, allow suitable flexing of the two side sections 511 to allow installation onto the cookware handle 503, and will subsequently grasp or clasp the cookware handle 503 to maintain the installable push-on cookware handle insulator 500 in position when installed. The outer surfaces of the two side sections 511, and the outer surface of the bottom section 509, which collectively form the cold surface of the installable push-on cookware handle insulator 500, may also include raised grip bars and/or raised nubs, as illustrated in the embodiments of FIG. 2A and FIG. 2B.

Any of the cookware handle insulators in the various embodiments described herein, may be removed from a cookware handle, such as a pot handle, after installation, by pulling upward on the cookware handle insulator from one edge, to pull the cookware handle insulator off of, and away from, the cookware handle.

The various embodiments of the installable push-on cookware handle insulators herein described are formed from a suitable thermal insulating material, suitable to provide insulation for a person's hand and fingers to protect from the heat generated by cooking temperatures. For example, the installable push-on cookware handle insulators may be formed from a thermal insulating material such as, but not limited to, a synthetic rubber such as silicone. The thickness of the material forming the installable push-on cookware handle insulator will be suitable to allow flexibility of the slot edges, while providing suitable thermal insulation against cooking temperatures. Also, any suitable elastomeric material that provides the desired heat insulation and flexibility of material, so that the cookware handle insulator may be installed on a cookware handle, may be used in the various embodiments.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

1. A cookware handle insulator comprising:
a main body formed from a thermal insulating material and having a top and bottom with an outer surface providing a cold surface, the main body top outer surface being convex;
a slot aperture through the main body bottom surface, running longitudinally along an axis of the main body and providing an inner surface of the main body, the slot aperture providing a space to accommodate a longitudinal cookware handle, the inner surface providing a hot surface of the main body; and
flexible slot edges, extending substantially transversely to the main body longitudinal axis, inwardly toward the slot aperture and toward each other, having an inwardly sloping taper on each flexible slot edge outer surface that forms part of the cold surface, the inwardly sloping tapers forming a convex surface on the main body bottom surface that slopes inwardly into the slot aperture such that a longitudinal cookware handle surface initially contacts the convex surface on the main body bottom surface when the cookware handle insulator is pushed onto the cookware handle further such that the inwardly sloping tapers slide against the longitudinal cookware handle surface as the flexible slot edges are compressed into the slot aperture and subsequently snap outwardly and over the longitudinal cookware handle surface, such that flexible slot edge inner surfaces that form part of the hot surface, engage the longitudinal cookware handle surface and maintain the cookware handle insulator position on the cookware handle when the cookware handle insulator is installed on the cookware handle.

2. The cookware handle insulator of claim 1, the main body having a substantially c-shaped cross-section formed by the slot aperture and by the flexible slot edges.

3. The cookware handle insulator of claim 1, the main body being rotatable around a longitudinal axis of the longitudinal cookware handle when installed thereon.

4. The cookware handle insulator of claim 1, the main body having a cross-section formed by the slot aperture and by the flexible slot edges, where the cross-section is one of: square, rectangular, or triangular.

5. The cookware handle insulator of claim 2, the substantially c-shaped cross-section having an oval cross-section with the main body being flexible with respect to the main body height and the main body width.

6. The cookware handle insulator of claim 2, the main body outer surface comprising a series of alternating raised grip bars and nub pairs, extending outwardly from the main body outer surface.

7. The cookware handle insulator of claim 2, where the thermal insulating material is synthetic rubber.

8. The cookware handle insulator of claim 2, where the thermal insulating material is silicone.

9. A cookware handle insulator comprising:
a main body formed from a thermal insulating material, having an outer surface providing a cold surface, the main body comprising a bottom section and two side sections connected to, and forming acute angles with, the bottom section with respect to inner surfaces of the two side sections and the bottom section, the inner surfaces of the two side sections and the bottom section collectively forming a slot aperture providing a hot surface and providing a space to accommodate a longitudinal cookware handle, where the two side sections can flexibly clasp onto a longitudinal cookware handle surface and maintain the cookware handle insulator position on the cookware handle when the cookware handle insulator is installed on the cookware handle; and
two slot edges, each slot edge extending outwardly away from a corresponding side section of the two side sections and away from the slot aperture, each slot edge having a slot edge inner surface for engaging the longitudinal cookware handle surface when the cookware handle insulator is pushed onto the cookware handle.

10. The cookware handle insulator of claim 9, the main body having a substantially triangular shaped cross-section formed by the two side sections and the bottom section.

11. The cookware handle insulator of claim 9, the main body being rotatable around a longitudinal axis of the longitudinal cookware handle when installed thereon.

12. The cookware handle insulator of claim 10, the main body outer surface comprising a series of alternating raised grip bars and nub pairs, extending outwardly from the main body outer surface.

13. The cookware handle insulator of claim 10, where the thermal insulating material is synthetic rubber.

14. The cookware handle insulator of claim 10, where the thermal insulating material is silicone.

15. A method of installing a cookware handle insulator comprising:
aligning a longitudinal axis of a cookware handle insulator main body with a longitudinal axis of a cookware handle longitudinal surface, the cookware handle connected to a cookware item surface;
positioning flexible slot edges that extend inwardly toward a slot aperture of the cookware handle insulator with the cookware handle; and
applying a downward pressure to push the cookware handle insulator onto the cookware handle such that the flexible slot edges outer surfaces initially contact the cookware handle surface when the cookware handle insulator is pushed onto the cookware handle, further such that the flexible slot edges outer surfaces slide against the cookware handle longitudinal surface as the flexible slot edges are compressed into the slot aperture and subsequently snap outwardly and over the cookware handle surface, and
clasping the cookware handle by the flexible slot edge inner surfaces that form part of the hot surface, to engage the longitudinal cookware handle surface and maintain the cookware handle insulator position on the cookware handle when the cookware handle insulator is installed on the cookware handle and when the cookware handle is within the slot aperture.

16. The method of claim 15 comprising:
rotating the cookware handle insulator so that the slot aperture is positioned away from the cookware item surface.
